(19) United States
(12) Patent Application Publication
(10) Pub. No.: US 2010/0223717 A1
(43) Pub. Date: Sep. 9, 2010

(54) FIRE RESISTANT MATERIALS AND METHODS FOR MAKING SAME

(75) Inventors: David R. Foy, Edmonton (CA); Yuan Tan, Nantong (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Davis LLP, Vancouver (CA)

(21) Appl. No.: 12/435,142

(22) Filed: May 4, 2009

Related U.S. Application Data
(60) Provisional application No. 61/157,876, filed on Mar. 5, 2009.

(51) Int. Cl. A62B 17/00; D02G 3/00; D03D 15/12; C08L 5/00

(52) U.S. Cl. 2/458; 428/401; 442/301; 442/229; 524/34; 139/420 R; 139/425 R; 2/81

(57) ABSTRACT

There are disclosed fire resistant threads and fabrics comprising an intimate blend of natural and synthetic fibers. In embodiments the blends may comprise between 50% and about 98% of the natural fibers. The fabrics disclosed may further comprise conductive and/or strengthening filaments which may be disposed on one side of the fabric. The fabrics may have a reduced surface resistance and may be formed into garments. Methods for making the threads and fabrics are also disclosed.

### RELATED APPLICATION

This application claims priority to U.S. provisional patent application No. 61/157,876, filed Mar. 5, 2009. All patents, patent applications, and other publications cited in this application are incorporated by reference in the entirety for all purposes.

### BACKGROUND

1. Field

The subject matter disclosed generally relates to flame resistant materials and methods of manufacturing flame resistant materials.

2. Related Prior Art

Flame-resistant Nylon/Cotton fabrics are known in the art. For example, U.S. Pat. No. 5,468,545 to Fleming et al. discloses long wear life flame-retardant cotton blend fabrics. U.S. Pat. No. 4,812,144 to Hansen discloses a process for producing a flame resistant nylon/cotton fabric.

### SUMMARY

In an embodiment there is disclosed a fire resistant thread comprising an intimate blend of natural fibers and synthetic fibers.

In alternative embodiments the natural fiber may be chemically treated.

In alternative embodiments the natural fiber may comprise cotton and may comprise synthetic fiber comprises nylon.

In alternative embodiments the intimate blend comprises between about 50% and about 98% natural fibers and between about 50% and about 2% synthetic fiber.

In alternative embodiments the intimate blend comprises between about 80% natural fibers and about 95% natural fiber and between about 20% and about 5% synthetic fibers.

In alternative embodiments the intimate blend may comprise between about 85% natural fiber and about 95% natural fiber and between about 15% and about 5% synthetic fibers.

In alternative embodiments at least 90% of the natural fibers may have a length greater than about 10 mm.

In alternative embodiments at least 90% of the natural fibers may have a length greater than about 15 mm.

In alternative embodiments both the warp and weft of the fabric may comprise threads according to any one of claims 1 through 8.

In alternative embodiments the fabric further comprises a supplementary component selected from the group consisting of: a conductive strengthening thread; a conductive strengthening filament; a conductive thread, a conductive filament, a strengthening thread and strengthening filament.

In alternative embodiments the fabric comprises a conductive strengthening thread.

In alternative embodiments the fabric comprises a conductive strengthening filament.

In alternative embodiments the fabric comprises a conductive filament.

In alternative embodiments the fabric comprises strengthening thread.

In alternative embodiments the fabric comprises a strengthening filament.

In alternative embodiments the supplementary component may comprises mutually spaced elements and may be comprised only in the warp of the fabric.

In alternative embodiments the fabric has a first surface, and the supplementary component may be comprised in the first surface.

In alternative embodiments the supplementary component comprises stainless steel filaments.

In alternative embodiments the supplementary component comprises stainless steel fibers.

In alternative embodiments the natural fiber comprises cotton and the synthetic fiber comprises nylon

In alternative embodiments there is disclosed a method of making a fire resistant fabric, the method comprising the steps of:

forming a first thread from an intimate mixture of natural fibers and synthetic fibers;

forming a second thread from an intimate mixture of natural fibers and synthetic fibers,

weaving the fabric so that the first thread may be comprised in the weft of the fabric and the second thread may be comprised in the warp of the fabric

In alternative embodiments each of the first and second threads comprises between about 50% and about 98% of the natural fiber and between about 2% and about 50% of the synthetic fibers.

In alternative embodiments each of the first and second threads comprises between about 80% and about 95% of the natural fibers and between about 20% and about 5% of the synthetic fibers.

In alternative embodiments the intimate blend comprises between about 85% natural fiber and about 95% natural fiber and between about 15% and about 5% synthetic fibers.

In alternative embodiments the method further comprises weaving into the fabric a supplementary component selected from the group consisting of: a conductive strengthening thread; a conductive strengthening filament; a conductive thread, a conductive filament, a strengthening thread and strengthening filament.

In alternative embodiments the method may comprise a chemical treatment step to enhance the fire resistance of the fabric.

In alternative embodiments the method may further comprise weaving mutually spaced stainless steel filaments into the warp of the fabric.

In alternative embodiments the method may further comprise weaving mutually spaced stainless steel threads into the warp of the fabric.

In alternative embodiments there is disclosed a fire resistant garment comprising the fabric according to any of the embodiments.

In embodiments there is disclosed a fire resistant fabric having a surface with surface resistance of less than about 2.5 GΩ at the surface and In alternative embodiments both warp and weft comprise threads comprising an intimate mix of both natural and synthetic fibers.

In alternative embodiments the surface resistance may be less than about 2.0 GΩ.

In alternative embodiments the fabric comprises between about 50% and about 98% of the natural fiber and between about 2% and about 50% of the synthetic fibers.

In alternative embodiments the fabric comprises between about 45% and about 95% of the natural fiber and between about 5% and about 55% of the synthetic fibers.

In alternative embodiments the fabric comprises between about 40% and about 93% of the natural fiber and between about 7% and about 60% of the synthetic fibers.

In alternative embodiments the fabric comprises between about 35% and about 90% of the natural fiber and between about 10% and about 65% of the synthetic fibers.

In alternative embodiments the natural fiber comprises cotton and the synthetic fiber comprises nylon.

In alternative embodiments the fabric has a surface resistance of less than about 1.5 GΩ at least one surface.

In alternative embodiments the fabric comprises a supplementary component selected from the group consisting of: a conductive strengthening thread; a conductive strengthening filament; a conductive thread, a conductive filament, a strengthening thread and strengthening filament.

In alternative embodiments the fabrics further comprise a conductive strengthening thread woven at a surface of the fabric.

In alternative embodiments the fabrics may further comprise a stainless steel filament.

In alternative embodiment the fabrics may be formed into garments.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the subject matter hereof. Accordingly, the drawings and the description are to be regarded as illustrative in nature, and not as restrictive.

### BRIEF DESCRIPTION OF THE DRAWINGS

FIG. 1 is a flow chart showing the method according to an embodiment.

FIG. 2 is a flow chart of a process for treating materials according to an embodiment.

### DETAILED DESCRIPTION OF THE PREFERRED EMBODIMENTS

Terms:

In this disclosure, the word “comprising” is used in a non-limiting sense to mean that items following the word are included, but items not specifically mentioned are not excluded.

A reference to an element by the indefinite article “a” does not exclude the possibility that more than one of the elements is present, unless the context clearly requires that there be one and only one of the elements.

In this disclosure the recitation of numerical ranges by endpoints includes all numbers subsumed within that range including all whole numbers, all integers and all fractional intermediates (e.g., 1 to 5 includes 1, 1.5, 2, 2.75, 3, 3.80, 4, and 5 etc.).

In this disclosure the singular forms a “an”, and “the” include plural referents unless the content clearly dictates otherwise. Thus, for example, reference to a composition containing “a compound” includes a mixture of two or more compounds.

In this disclosure term “or” is generally employed in its sense including “and/or” unless the content clearly dictates otherwise.

In this disclosure, unless otherwise indicated, all numbers expressing quantities or ingredients, measurement of properties and so forth used in the specification and claims are to be understood as being modified in all instances by the term “about”. Accordingly, unless indicated to the contrary or necessary in light of the context, the numerical parameters set forth in the disclosure are approximations that can vary depending upon the desired properties sought to be obtained by those skilled in the art utilizing the teachings of the present disclosure and in light of the inaccuracies of measurement and quantification. Without limiting the application of the doctrine of equivalents to the scope of the claims, each numerical parameter should at least be construed in light of the number of reported significant digits and by applying ordinary rounding techniques. Not withstanding that the numerical ranges and parameters setting forth the broad scope of the disclosure are approximations, their numerical values set forth in the specific examples are understood broadly only to the extent that this is consistent with the validity of the disclosure and the distinction of the subject matter disclosed and claimed from the prior art.

In this disclosure the word “fabric” means a cloth or other material made by weaving, knitting, felting or otherwise assembling threads and/or fibers and/or filaments and/or yarns.

In this disclosure the terms “thread” “yarn” “fiber” “filament” and the like are to be understood in their broadest sense consistent with their context, the overall meaning of the disclosure and any specific definitions presented herein. The reference to a fiber, thread or filament herein does not preclude its incorporation within a yarn or other structure.

In this disclosure the term “yarn” refers to a structure comprising a plurality of strands that have been twisted, spun or otherwise joined together to form the yarn and may include spun yarns, continuous filament yarns, and yarns of core spun construction. Yarns according to the invention may be manufactured using virtually any yarn-forming process known in the art but in particular embodiments may be manufactured by spinning or stretch broken spinning.

A used in this disclosure the terms “fiber” and “fibers”, refer to any slender, elongated structure that can be carded, combed, or otherwise formed into a thread. Fibers may be of various lengths and in particular embodiments individual fibers may have a length of up to about 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, 220 mm, 240 mm, 260 mm, 280 mm, 300 mm, or longer. Examples include “staple fibers”, a term that is well-known in the textile art. The term “fiber,” differs from the term “filament,” which is defined separately below. A reference to “fiber” of “fibers” may mean or include individual fibers or a plurality or bulk of fibers as the situation requires. A plurality of fibers may comprise fibers of different compositions or may be substantially uniform in composition. Thus, by way of illustration, a reference to “natural fiber” or “synthetic fiber” may mean and may include a single fiber of such type, or may mean any quantity or plurality of such fibers and they may be comprised in threads, felts, yarns, fabrics materials etc., all as will be apparent from the context.

In this disclosure the term “thread” refers to continuous or discontinuous elongated strands formed by carding or otherwise joining together one or more different kinds of fibers. The term “thread” differs from the term “filament”, which is defined separately. In embodiments threads may be incorporated into yarns or other structures comprising a plurality of threads, before being woven to form fabrics.

In this disclosure the term “filament”, refers to a single, continuous or discontinuous elongated strand formed from one or more metals, ceramics, polymers or other materials and that has no discrete sub-structures (such as individual fibers that make up a “thread” as defined herein). “Filaments” can be formed by extrusion, molding, melt-spinning, film cutting, or other known filament-forming processes. A “filament” differs from a “thread” in that a filament is, in essence, one continuous fiber or strand rather than a plurality of fibers that have been carded or otherwise joined together to form a thread. “Filaments” are characterized as individual fibers of great length. In particular embodiments filaments may be or may comprise steel, stainless steel, carbon fiber, ceramic or other suitable materials all of which will be readily apparent to and selected from by those skilled in the art. Filaments used in embodiments may have a high tensile strength, or may have high conductivity or may be suitable to act as an anti-static component, or may have both high tensile strength and anti-static or conducting properties. Examples of metals used to form high strength filaments may include, but are not limited to, stainless steel, stainless steel alloys, other steel alloys, titanium, aluminum, copper, and other metals or metallic alloys. In addition to, or instead of, metallic filaments, other strengthening filaments can be used, such as high strength ceramic filaments (e.g., based on silicon carbide, graphite, silica, aluminum oxide, other metal oxides, and the like), and high strength polymeric filaments (e.g., p-aramides, m-aramides nylon, and the like). In embodiments fiberglass filaments can also be used. In embodiments filaments may be blended with other strengthening filaments or fibers to produce threads or yarns.

In this disclosure “conductive strengthening thread” means and includes threads consisting of or comprising any suitable metal or other conductive material having a suitable tensile strength and conductivity for desired purposes. In particular embodiments, conductive strengthening thread may comprise one or more of steel, stainless steel, steel alloy, titanium, titanium alloy, aluminium, aluminum alloy, copper, copper alloy, carbon fiber, graphite fiber, or any other suitable combination of conductive and strengthening materials. Metal thread includes but is not limited to metal filaments which filaments may comprise any metallic filament known in the art. In general, preferred metallic filaments include those which are noncorrosive and high in tensile strength. In embodiments any materials suitable for forming strengthening and/or conductive filaments may also be used to form conductive strengthening threads. In particular embodiments the conductive strengthening threads may include or may be BEKINOX™ threads produced by BEKAERT™.

In this disclosure “natural fibers” includes cotton, wool, viscose, flax, silk, jute, hemp and all like materials that may be useable for the purposes set out herein. In embodiments the natural fiber may be cotton, may be grade 1, grade 2, grade 3, or grade 4 cotton, and may be Tanguis, Pima, Indian, South American, or Egyptian cotton. In embodiments natural fibers may be chemically or otherwise treated or processed to enhance or confer desirable properties such as fire resistance, water resistance, strength and the like.

In this disclosure “nylon” has its ordinary meaning and includes nylon-66 and the full range of chemical variants on nylon which may be suitable for the purposes set forth. All of these will be recognized, understood and selected from by those skilled in the art.

In this disclosure the term “synthetics”, “synthetic fibers”, “synthetic materials” and the like, have their ordinary meaning and denote materials that have been chemically synthesised rather than harvested from natural sources. They may be or may comprise or may have chemical and/or physical properties equivalent to or similar to nylon and may be or may comprise, nylon (which may be Nylon 6,6), rayon, polypropylene, polyethylene, fire resistant polyester, polyarene, polbenzimidazole, polyphenylene-2,6-benzobisoxazole, modacrylic, p-arfamid, m-aramid, polyvinyl halide, preoxidised acrylic fibers, high temperature nylon (such as KEVLAR,®) silica fibers, glass fibers, metalized aramid or other fibers and may comprise fire resistant modifications of any of the foregoing.

As used in this disclosure the term “nylon” means any polyamide fibres formed by the condensation between an amino group of one molecule and a carboxylic acid group of another. These may include but are not limited to common nylon fibres, such as nylon 6 (eg. ENKALON™, CELON™), nylon 6,6 (“Bri-nylon”), and nylon 6,10. A wide range of alternatives and modifications will be readily apparent to those skilled in the art as will the choice therebetween and the use thereof.

In this disclosure the term “supplementary component” means any threads, fibers, filaments, yarns, chemicals, or materials of any kind that may be capable of incorporation into fabrics or threads to confer desirable chemical and/or physical properties such as electrical or heat conductance, water resistance, physical strength or durability, chemical resistance and the like. In embodiments the supplementary components may comprise strengthening threads, strengthening filaments, conducting threads, conducting filaments, conducting strengthening threads and conducting strengthening filaments. In embodiments such supplementary components may be comprised in the warp or weft or both warp and weft of a fabric and may be mutually spaced and may be incorporated by weaving into the fabric or b other forms of association and may be localised proximate to one surface of a fabric. By describing a component as being “at” or “proximate” a surface is meant that the component is provided at, on, or near that surface and that the component may be substantially absent from or hidden from view from the other surface of the fabric, such description will be readily understood by those skilled in the art. In embodiments the supplementary component or components may comprise individual elements (by way of example individual elements may be individual threads fibers, filaments, or yarns), which may be mutually spaced over a portion of their length and may be provided only in the warp or only in the weft of the fabric.

In this disclosure the term “fire resistant” refers to a fabric, felt, yarn or strand that is self extinguishing or that will not burn or that is able to withstand exposure to heat or flame substantially without losing its strength or integrity. Different degrees of fire resistance may be achievable with different embodiments and under different testing conditions, examples of such testing conditions being provided by relevant safety standards imposed by various regulatory authorities.

In general, heat degrades fibers and fabrics at different rates depending on fiber chemistry, the level of oxygen in the surrounding atmosphere of the fire, and the intensity of fire and heat. There are a number of different tests used to determine a fabric's flame retardance and heat resistance rating, including the Limiting Oxygen Index, continuous operating temperature, and Thermal Protective Performance.

In this disclosure the term “continuous operating temperature” means the maximum temperature or temperature range at which a particular fabric, yarn, thread, fiber, filament, thread or material will maintain strength and integrity over time when exposed to constant heat at a given temperature or temperature range.

In this disclosure the term “tensile strength” refers to the maximum amount of stress that can be applied to a material before rupture or failure. The “tear strength” is the amount of force required to tear a fabric. In general, the tensile strength of a fabric relates to how easily the fabric will tear or rip. The tensile strength may also relate to the ability of the fabric to avoid becoming permanently stretched or deformed. The tensile and tear strengths of a fabric should be high enough so as to prevent ripping, tearing, or permanent deformation of the garment in a manner that would significantly compromise the intended level of thermal protection of the garment. In embodiments a full range of conventional modifications may be made to the threads, fabrics and methods to improve tensile strength, tear strength and continuous operating temperature.

In this disclosure the term “fabric,” refers to one or more different types of yarns, threads, filaments, or fibers that would have been woven, knitted, felted, wrapped, spun, co-mingled, coated, coextruded, braided, entangled, applied or otherwise assembled into a desired material.

When measuring yarn, thread, fabric or the like, both volume and weight measurement may be applicable. Generally, volumetric measurements will be used when measuring the concentrations of the various components of the entire yarn, including threads and filaments, whereas weight measurements will typically be used when measuring the concentrations of one or more staple fibers within the thread or strand portion of the yarn. Where supplementary components are incorporated into a fabric, or chemical treatments are carried out that substantially alter the volume or weight of the fabric, the percentages of natural and/or synthetic components recited herein refer to the fabric before the incorporation of such supplementary components or the carrying out of such treatments and essentially represent the ratio between the quantities of natural and synthetic fibers used.

The yarns and threads disclosed can be woven, knitted, or otherwise assembled into fabric and the fabrics disclosed can be used to make a wide variety of articles of manufacture. Examples include, but are not limited to, garments, clothing, jump suits, gloves, socks, welding bibs, fire blankets, floor boards, padding, protective head gear, linings, cargo holds, mattress insulation, drapes, insulating fire walls, and the like.

### Embodiments

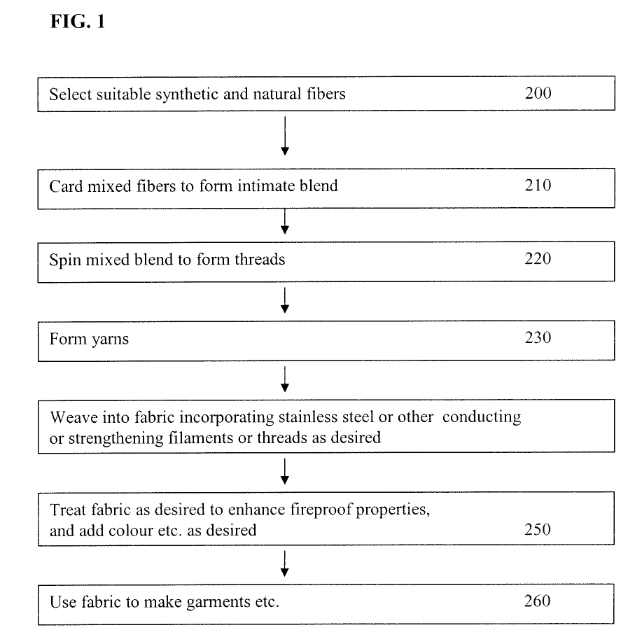

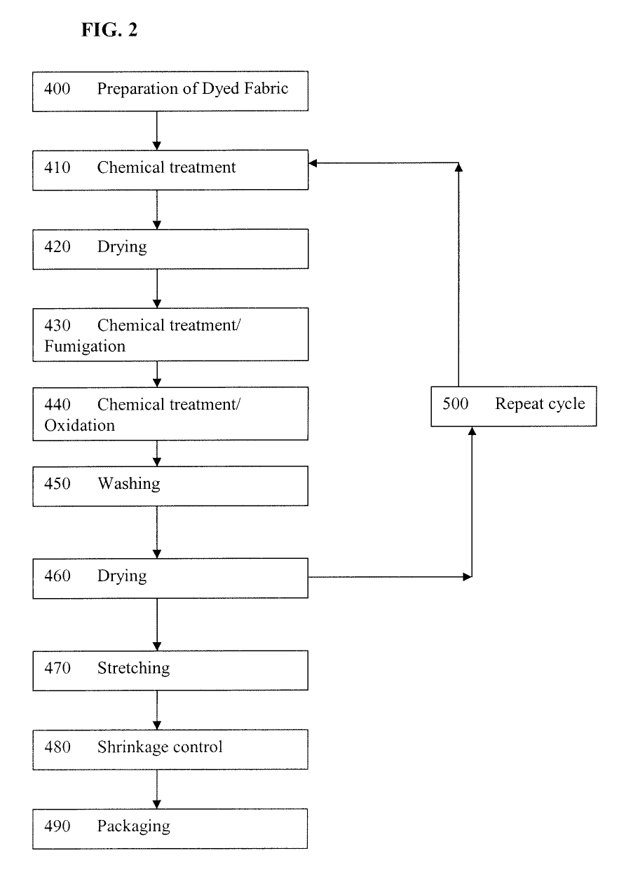

Embodiments are described generally with reference to FIGS. 1 and 2.

In a first embodiment there is disclosed a fire resistant thread comprising an intimate blend of natural fibers and synthetic fibers.

In alternative embodiments the fibers used may be longer than at least about 5 mm, 10 mm, 12 mm, 14 mm, 16 mm, 18 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, or 100 mm or may be longer than at least 100 mm. The fibers may be intimately mixed and then spun.

In particular embodiments the intimate blend may comprises between about 50% and about 98% natural fibers and between about 50% and about 2% synthetic fiber. In further embodiments the intimate blend may comprise between about 80% natural fiber and about 95% natural fiber and between about 20% and about 5% synthetic fibers. 90% or more of said natural fibers may have a length greater than about lOmm. In alternative embodiments, the percentage of natural fiber in the thread may be of any suitable ranges. Such suitable ranges may be between about 30% and 35%, between 35% and 40%, between about 45% and 50%, between about 50% and 55%, between about 55% and 60%, between about 65% and 70%, between about 70% and 75%, between about 75%-80%, between about 80% and 85%, between about 85% and 90%, and between about 90% and 95% or may be greater than about 95%. In an embodiment the synthetic may be nylon and may be Nylon 66. The natural fiber may be cotton and the fibers selected may be greater than 16 mm long.

In alternative embodiments, the percentage of synthetic in a thread or a fabric made therefrom may be of any suitable range. Such suitable ranges may be between about 0% and 5%, between about 5% and 10%, between about 10% and 15%, between about 15% and 20%, between about 20% and 25%, between about 25% and 30%, between about 30% and 35%, between about 35% and 40%, between about 40% and 45%, between about 45% and 50%, between about 50% and 55%, between about 55% and 60%, between about 60% and 65%, between about 65% and about 70% or greater than about 70%.

In embodiments the natural fiber and/or synthetic fiber and/or fabrics made therefrom may be chemically treated to enhance its fire resistance in ways readily understood by those skilled in the art. Such treatment may be carried out before or after the forming of threads of fabrics. In embodiments the chemical treatment may comprise treatment with PYROSET™ and alternative or additional suitable treatment chemicals may be obtainable from Cytec Industries Inc. and other manufacturers. In one embodiment chemical treatment may be carried out to improve fire resistance. This may comprise treatment with a variety of fireproofing and other reagents such as hydroxymethyl reagents, THCP and the like . Such treatment may be carried out after dyeing and may include multiple cycles of treatment as illustrated in FIG. 2. A variety of alternative treatments to improve fire resistance properties of the threads and fabrics according to embodiments will be readily recognised and implemented by those skilled in the art, and may include the PYROSET™ process. In embodiments treatments to improve the fire resistance properties of fabrics may include the use of any suitable chemicals. By way of example and not of limitation these may include organophosphorus chemicals, nitrogen based chemicals, halogenated chemicals or halogenation. In embodiments treatments may include the use of hydroxymethyl phosphonium salts such as chlorides (THCP) or ammonium salts (THPX), Dimethyl phosphono(N-methylol)propionamide, Diguanidine hydrogen phosphate, Aromatic phosphates, Dimethyl hydrogen phosphite (DMHP), Melamine (nitrogen based), Phosphonitrilic chloride (PNC) and pentabromodiphenyl ether. In particular embodiments treatment may comprise treament with a urea and tetrakis(hydroxymethyl)phosphonium salt A wide range of alternative and equivalent chemicals and procedures will be readily apparent to those skilled in the art. All such treatments, suppliers and chemicals will be readily apparent to those skilled in the art who will be able to choose between them and use them for treatments. A scheme for one possible chemical treatment procedure is set forth in FIG. 2 and multiple cycles of treatment may be used. Further details of possible treatments are set forth elswhere in this disclosure.

In embodiments the threads may be woven or otherwise formed into fabrics and garments.

In a second embodiment there is disclosed a flame resistant fabric wherein both the warp and weft of the fabric may comprise the threads according the first embodiment. In embodiments the both warp and weft may consist primarily or exclusively of threads according to the first embodiment. The fabric may be woven, and the warp and/or weft of the fabric may further comprise supplementary components selected from the group consisting of: conductive strengthening threads; conductive strengthening filaments; conductive threads, conductive filaments, strengthening threads and strengthening filaments. The supplementary components may be mutually spaced and may be comprised only in the warp of the fabric. The fabric may have a first surface and the supplementary components may be comprised in the first surface. The supplementary components may be or may compromise stainless steel filaments. In alternative embodiments, the supplementary component content of fabrics according to embodiments may be from about: 0.5%-1.0%, 1.0%-1.5%, 1.5%-2.0%, 2.0%-2.5%, 2.5%-3.0%, 3.0%-3.5%, 3.5%-4.0%, 4.5%-5.0%, 5.0%-5.5%, 5.5%-6.0%, 6.0%-6.5%, 6.5%-7.0%, 7.0%-7.5%, 7.5%-8.0%, 8.0%-8.5%, 8.5%-9.0%, 9.5%-10.0%, 10%-11%, 11%-12%, 12%-13%, 13%-14%, 14%-15% or greater than about 15%. In alternative embodiments the metal thread content of fabric according to an embodiment may be greater than about: 1%, 2%, 3%, 4%, 5%, 6%, 7%, 8%, 9%, 10%, 11%, 12%, 13%, 14%, 15%, 16%, 17%, 18%, 19% 20%, 21%, 22%, 23%, 24%, 25% or greater. In further alternative embodiments the fabric may be less than about: 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25% of supplementary component which may comprise a metal thread.

In alternative embodiments the threads and the fabric made from the intimately blended natural and synthetic fibers may be up to about: 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 100%, 110%, 120%, 130%, 140%, 150% or more stronger than fabric woven from conventional cotton fibers.

In a third embodiment there is disclosed a method for making a fire resistant fabric. The method may comprise the steps of: forming a first thread from an intimate mixture of natural fibers and synthetic fibers; forming a second thread from an intimate mixture of natural fibers and synthetic fibers, weaving the fabric so that the first thread is comprised in the weft of the fabric and the second thread is comprised in the warp of the fabric. In particular embodiments the threads may be those of the first embodiment and in embodiments each of the first and second threads may comprise between about 50% and about 98% of the natural fibers and between about 2% and about 50% of the synthetic fibers. In further embodiments the first and second threads may comprise between about 80% and about 95% of the natural fibers and between about 20% and about 5% of the synthetic fibers. The method may comprise weaving mutually spaced conductive strengthening filaments into the warp of the fabric. The method may include the further steps of chemically treating the fabric to enhance the fire resistance of the threads and/or weaving mutually spaced conductive strengthening threads into the warp of the fabric.

An embodiment of the method is broadly illustrated in FIG. 1. In a first step 200, suitable natural and synthetic fibers are selected and are then carded together or otherwise mixed 210 to form an intimate blend. The intimate blend is spun 220 to form thread which may be used to form yarns 230, The yarns may be woven 240 to form a fabric, which may incorporate strengthening an/or conducting threads of filaments as desired. The fabric may be treated 250 to enhance its properties, to dye it or for any other purpose. The fabric thus produced may be used 260 to form garments or other articles of manufacture. It will be appreciated that in particular embodiments some of these steps may be omitted, modified or their sequence altered, as necessary or desirable for particular purposes.

In embodiments chemical treatment may comprise all or part of the process shown in FIG. 2. The dyed undyed fabric 400 may be treated 410 with suitable chemicals and in suitable ways to enhance its properties, dried 420, fumigated 430, oxidised 440, washed 450, dried 460, stretched 470, and then go through a quality control or shrinkage control step 480 which may include additional treatments before packaging 490 or use. In embodiments the sequence of steps from treatment 410 through to washing or drying or stretching 470 may be repeated 500 two or more times as desired. Additional steps may be incorporated to shrink, colour, texture, shape, perforate, seal, strengthen, or otherwise modify the fabric, all of which will be readily understood and applied by those skilled in the art. In embodiments the sequence of steps may be changed or steps may be added, omitted or modified in ways readily apparent to those skilled in the art.

In a fourth embodiment there are disclosed fire resistant garments comprising the fabric according to any of the embodiments.

In a fifth embodiment there is disclosed a fire resistant fabric with surface resistance of less than about 2.5 GΩ on at least one surface and warp and/or weft may comprise threads comprising an intimate mix of both natural and synthetic fibers. In embodiments the fabric may comprise between about 20% and about 2% of said synthetic fiber. In embodiments the fabric may have a surface resistance of less than about 1.5 GΩ on at least one surface. In embodiments the fabric may comprise a conductive strengthening thread or filament which may be woven into a side of the fabric.

Garments can be prepared from the fabric of embodiments in conventional ways and additional reflective or protective materials can be added to or combined with the fabric for a particular applications.

In embodiments the fabrics and materials disclosed may have a surface resistivity that approximates any integer between 0 and 1×10⁴⁰ Ω/sq and may be greater or less than about 1×10⁵ Ω/sq, 1×10⁷ Ω/sq,. 1×10¹⁰ Ω/sq, 1×10¹⁵ Ω/sq, 1×10²⁰ Ω/sq, 1×10²⁵ Ω/sq, 1×10^{30 Ω/sq,} 1×10³¹ Ω/sq, 1×10³² Ω/sq, 1×10³³ Ω/sq, 1×10³⁴ Ω/sq, 1×10³⁵ Ω/sq, 1×10³⁶ Ω/sq, 1×10³⁷ Ω/sq, 1×10³⁸ Ω/sq, 1×10³⁹ Ω/sq, 1×10⁴⁰ Ω/sq, 1×10⁴¹ Ω/sq, 1×10⁴² Ω/sq, 1×10⁴⁴ Ω/sq, 1×10⁴⁶ Ω/sq, 1×10⁴⁸ Ω/sq, 1×10⁵⁰ Ω/sq, In embodiments the fabrics and materials may have a resistance of less than about 2.5 GΩ, and in alternative embodiments the resistance may be less than about 2.0 GΩ, 1.5 GΩ, 1.0 GΩ, 0.5 GΩ, 100MΩ, 50MΩ, 10MΩ, 1MΩ, 100 kΩ, 50 kΩ, 10 kΩ, 1 kΩ, 900Ω, 800Ω, 700Ω, 600Ω, 500Ω, 400Ω, 300Ω, 200Ω, 100Ω, 90Ω, 80Ω, 70Ω, 60Ω, 50Ω, 40Ω, 30Ω, 20Ω, 10Ω or may have a resistance that approximates any integer between 1 and 1,000,000,000Ω or in alternative embodiments may be greater than any of the foregoing levels of resistance.

In embodiments the supplementary components, which may be metal threads or filaments, may be embedded in or associated with a surface of the fabric and may comprise a plurality of such threads or filaments and any two of such threads or filaments may be substantially parallel over a part of their length and may be mutually distanced at a distance of up to or less than about, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 25 mm, 30 mm, 40 mm or more or at a distance that approximates any integer between 1 and 100 mm.

In embodiments the fire resistant threads, yarns, fabrics and articles of manufacture disclosed may satisfy the requirements established by the Canadian General Standards Branch (“CGSB”) and/or the ARC Thermal Performance Value (“ATPV”) as determined by suitably qualified testing authorities.

Chemical treatment of the fabric may be carried out in conventional ways as set forth herein.

### EXAMPLE 1

In a first example the nylon used is Nylon 66. The cotton and nylon materials are mixed together and then combed and spun to form cotton nylon thread or yarn. Cotton selected to make threads and yarns comprises fibers more than 16 mm long . The threads or yarns are woven into a fabric in which the warp and weft of the fabric are both made of the cotton-nylon blend. The resulting fabric may be 30% stronger than ordinary combed cotton fabrics and is further strengthened by embedding stainless steel fibers on a surface of the fabric and making up about 3% of the final fabric.

The specifications of fabrics made according to the Example are as follows:

9 OZ FABRIC; 12×12 THICKNESS; 83×49/67″; 93×50/59″; 3/1 WEAVE.

7 OZ FABRIC; 16×12; 83×42/67; 93×43;59″; 3/1 WEAVE.

Tables 1 and 2 show the results of testing carried out on samples of material according to the example. In Table 1: Sample A refers to a 7 ounce fabric according to the example and Sample B refers to a 9 ounce fabric according to the example

TABLE 1

| | | | Resistance | | Resistivity | |
|---|---|---|---|---|---|---|
| Sample | Side | Measurement | (Ω) | | (Ω/sq) | |
| Sample A | 1 | 1 | 45.8 | Ω | 0.9 | KΩ/sq |
| | | 2 | 63.3 | Ω | 1.2 | KΩ/sq |
| | | 3 | 60.8 | Ω | 1.2 | KΩ/sq |
| | | 4 | 52.5 | Ω | 1.0 | KΩ/sq |
| | | 5 | 57.5 | Ω | 1.1 | KΩ/sq |
| | GMeans | | 55.6 | Ω | 1.1 | KΩ/sq |
| | 2 | 1 | 694 | MΩ | 13.7 | GΩ/sq |
| | | 2 | 533 | MΩ | 10.5 | GΩ/sq |
| | | 3 | 1.2 | KΩ | 23.8 | KΩ/sq |
| | | 4 | 599 | MΩ | 11.9 | GΩ/sq |
| | | 5 | 419 | MΩ | 8.3 | GΩ/sq |
| | GMeans | | 39.2 | MΩ | 776.6 | MΩ/sq |
| Sample B | 1 | 1 | 62.5 | Ω | 1.2 | KΩ/sq |
| | | 2 | 54.2 | Ω | 1.1 | KΩ/sq |
| | | 3 | 69.2 | Ω | 1.4 | KΩ/sq |
| | | 4 | 63.3 | Ω | 1.3 | KΩ/sq |
| | | 5 | 95.8 | Ω | 1.9 | KΩ/sq |
| | GMeans | | 67.7 | Ω | 1.3 | KΩ/sq |
| | 2 | 1 | 567 | MΩ | 11.2 | GΩ/sq |
| | | 2 | 558 | MΩ | 11.0 | GΩ/sq |
| | | 3 | 828 | MΩ | 16.4 | GΩ/sq |
| | | 4 | 726 | MΩ | 14.3 | GΩ/sq |
| | | 5 | 922 | MΩ | 18.3 | GΩ/sq |
| | GMeans | | 706 | MΩ | 14.0 | GΩ/sq |

In Table 2:

Sample A ref refers to a woven fabric of 340 g/m² with Bekinox 50/2 strips incorporated into one side of the fabric with a separation of about 14 mm

Sample B refers to a woven fabric of 270 g/m² with Bekinox 50/2 stripes incorporated into one side with a separation of about 14 mm

TABLE 2

| | | | Resistance | | Resistivity | |
|---|---|---|---|---|---|---|
| Sample | Side | Measurement | (ohm) | | (ohm/sq) | |
| Sample A | 1 | 1 | 93.3 | Ω | 3.2 10³ | Ω |
| | | 2 | 89.2 | Ω | 3.5 10³ | Ω |
| | | 3 | 96.7 | Ω | 2.8 10³ | Ω |
| | | 4 | 85.8 | Ω | 4.0 10³ | Ω |
| | | 5 | 89.2 | Ω | 2.6 10³ | Ω |
| | GMeans | | 90.8 | Ω | 1.8 10³ | Ω |
| | 2 | 1 | >2.5 10⁹ | Ω | >4.5 10¹⁰ | Ω |
| | | 2 | >2.5 10⁹ | Ω | >4.5 10¹⁰ | Ω |
| | | 3 | >2.5 10⁹ | Ω | >4.5 10¹⁰ | Ω |
| | | 4 | >2.5 10⁹ | Ω | >4.5 10¹⁰ | Ω |
| | | 5 | >2.5 10⁹ | Ω | >4.5 10¹⁰ | Ω |
| | GMeans | | >2.5 10⁹ | Ω | >4.5 10¹⁰ | Ω |
| Sample B | 1 | 1 | 80.0 | Ω | 1.6 10³ | Ω |
| | | 2 | 77.5 | Ω | 1.5 10³ | Ω |
| | | 3 | 95.8 | Ω | 1.9 10³ | Ω |
| | | 4 | 105.8 | Ω | 2.1 10³ | Ω |
| | | 5 | 80.0 | Ω | 1.6 10³ | Ω |
| | GMeans | | 87.2 | Ω | 1.7 10³ | Ω |
| | 2 | 1 | >2.5 10⁹ | Ω | >4.5 10¹⁰ | Ω |
| | | 2 | >2.5 10⁹ | Ω | >4.5 10¹⁰ | Ω |
| | | 3 | >2.5 10⁹ | Ω | >4.5 10¹⁰ | Ω |
| | | 4 | >2.5 10⁹ | Ω | >4.5 10¹⁰ | Ω |
| | | 5 | >2.5 10⁹ | Ω | >4.5 10¹⁰ | Ω |
| | GMeans | | >2.5 10⁹ | Ω | >4.5 10¹⁰ | Ω |

The embodiments and examples presented herein are illustrative of the general nature of the subject matter claimed and are not limiting. It will be understood by those skilled in the art how these embodiments can be readily modified and/or adapted for various applications and in various ways without departing from the spirit and scope of the subject matter disclosed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety. It will be appreciated that any aspects of the different embodiments disclosed herein may be combined in a range of possible alternative embodiments, and alternative combinations of features, all of which varied combinations of features are to be understood to form a part of the subject matter hereof.

The embodiments of the invention in which an exclusive property or privilege is claimed are defined as follows:

1. A fire resistant thread comprising an intimate blend of natural fiberand synthetic fibers.

2. The thread according to claim 1 wherein said natural fiber is chemically treated.

3. The thread according to claim 2, wherein said intimate blend comprises between about 50% and about 98% natural fiberand between about 50% and about 2% synthetic fiber.

4. The thread according to claim 3 wherein said intimate blend comprises between about 80% natural fiber and about 95% natural fiber and between about 20% and about 5% synthetic fibers.

5. The thread according to claim 3, wherein at least 90% of said natural fiberhave a length greater than about 10 mm.

6. A flame resistant fabric wherein both the warp and weft of said fabric comprise the threads according to claim 3.

7. The fabric according to claim 6 wherein said fabric further comprises a supplementary component selected from the group consisting of: a conductive strengthening thread; a conductive strengthening filament; a conductive thread, a conductive filament, a strengthening thread and strengthening filament.

8. The fabric according to claim 7 wherein said supplementary component comprises mutually spaced elements comprised only in the warp of said fabric.

9. The fabric according to claim 6 wherein said fabric has a first surface, and said supplementary component is localised proximate said first surface.

10. The fabric according to claim 9 wherein said supplementary component comprises a stainless steel filament.

11. A method of making a fire resistant fabric, said method comprising the steps of:
forming a first thread from an intimate mixture of natural fiberand synthetic fibers;
forming a second thread from an intimate mixture of natural fiberand synthetic fibers,
weaving said fabric so that the first thread is comprised in the weft of the fabric and the second thread is comprised in the warp of the fabric
wherein each of said first and second threads comprises between about 50% and about 98% of said natural fiber and between about 2% and about 50% of said synthetic fibers.

12. The method according to claim 11 wherein each of said first and second threads comprises between about 80% and about 95% of said natural fiberand between about 20% and about 5% of said synthetic fibers.

13. The method according to claim 11 wherein said method further comprises weaving into said fabric a supplementary component selected from the group consisting of: a conductive strengthening thread; a conductive strengthening filament; a conductive thread, a conductive filament, a strengthening thread and strengthening filament.

14. The method according to claim 11 further comprises a chemical treatment step to enhance the fire resistance of said fabric.

15. The method according to claim 12 further comprising weaving mutually spaced stainless steel filaments into the warp of said fabric.

16. A fire resistant garment comprising the fabric according to any one of claims 6 through 10.

17. A fire resistant fabric having a surface with surface resistance of less than about 2.5 GΩ at said surface and wherein both warp and weft comprise threads comprising an intimate mix of both natural and synthetic fibers.

18. The fire resistant fabric according to claim 17 wherein said fabric comprises between about 20% and about 2% of said synthetic fiber.

19. The fire resistant fabric according to claim 18 wherein said fabric has a surface resistance of less than about 1.5 GΩ on at least one surface.

20. The fire resistant fabric according to claim 18 further comprising a supplementary component selected from the group consisting of: a conductive strengthening thread; a conductive strengthening filament; a conductive thread, a conductive filament, a strengthening thread and strengthening filament.
